(19) United States
(12) Patent Application Publication
(10) Pub. No.: US 2017/0127452 A1
(43) Pub. Date: May 4, 2017

(54) RANDOM ACCESS TRANSMISSION OPPORTUNITY TERMINATION

(71) Applicant: Nokia Technologies Oy, Espoo (FI)

(72) Inventors: Wessam Afifi Ahmed, Tucson, AZ (US); Enrico-Henrik Rantala, Berkeley, CA (US); Sayantan Choudhury, Berkeley, CA (US); Jarkko Kneckt, Espoo (FI)

(21) Appl. No.: 14/926,558

(22) Filed: Oct. 29, 2015

(51) Int. Cl. H04W 74/08; H04W 72/04

(52) U.S. Cl. CPC H04W 74/0833; H04W 72/0446

(57) ABSTRACT

Various implementations described herein are directed to a method for terminating a transmission opportunity. The method may transmit an indication of a channel reservation for a transmission opportunity comprising a busy tone slot and a plurality of resource elements. The method may determine whether busy tone signals were received during the busy tone slot. If no busy tone signals were received during the busy tone slot, the method may terminate the transmission opportunity prior to a scheduled end time of the channel reservation.

### BACKGROUND

Increasing demand for wireless services and higher data rates result in ever increasing requirements for communication efficiency and wireless spectrum use. Random access wireless networks that may be configured to communicate with a number of different types of wireless devices are one type of wireless network in which such improvements are needed.

### BRIEF SUMMARY

This Summary is provided to introduce a selection of concepts in a simplified form that are further described below in the Detailed Description. This Summary is not intended to identify key features or essential features of the various embodiments, nor is it intended to be used to limit the scope of the claims.

A random-access transmission opportunity may be used for communication with wireless devices, which may be referred to as stations. At the beginning of the transmission opportunity, the wireless devices may indicate that they intend, request, or are configured to communicate with the access point. The wireless devices may indicate that they intend to communicate with the access point by transmitting a signal to the access point. The access point may detect whether or not any signals were transmitted by wireless devices. If no wireless devices intend, or requested, to use the transmission opportunity, the access point may terminate the transmission opportunity early, rather than waiting until the end of the full transmission opportunity. If the access point detects one or more signals from the wireless devices, and the full transmission opportunity occurs, wireless devices that were unable to successfully communicate with the access point during the transmission opportunity, or wireless devices that request to transmit more data, may transmit a second signal to the access point. If the access point receives the second signal, the access point may schedule a new transmission opportunity.

The access point may measure an energy level of signals transmitted by the wireless devices. Based on the measured energy level, the access point may determine a duration for the transmission opportunity or a time until the transmission opportunity is scheduled to begin.

Other aspects are discussed further below.

### BRIEF DESCRIPTION OF THE DRAWINGS

Certain embodiments are illustrated by way of example and not limited in the accompanying figures in which like reference numerals indicate similar elements and in which:

FIG. 1 is a diagram of an example communication system in which one or more embodiments may be implemented.

FIG. 2 illustrates a narrowband transmission diagram according to one or more embodiments described herein.

FIG. 3 illustrates a random access transmission opportunity according to one or more embodiments described herein.

FIG. 4 is a method for wireless communications according to one or more embodiments described herein.

FIG. 5 illustrates a method for initiating and terminating a transmission opportunity according to one or more embodiments described herein.

FIG. 6 illustrates a terminated transmission opportunity according to one or more embodiments described herein.

FIG. 7 illustrates a transmission opportunity with no failed devices according to one or more embodiments described herein.

FIG. 8 illustrates a method for determining a transmission opportunity duration according to one or more embodiments described herein.

FIG. 9 illustrates a block diagram of an example communication device according to one or more embodiments described herein.

### DETAILED DESCRIPTION

In the following description of various illustrative embodiments, reference is made to the accompanying drawings, which form a part hereof, and in which are shown by way of illustration various embodiments in which aspects described herein may be practiced. It is to be understood that other embodiments may be utilized and structural and functional modifications may be made without departing from the scope of the described aspects and embodiments.

An access point and a wireless device may communicate via a wireless protocol, such as the Wi-Fi protocol. To communicate with the access point, the wireless device may execute authentication and association protocols. Authentication may be a handshake process during which the wireless device establishes its identity with the access point. Examples of authentication methods include open system authentication and shared key authentication. Association may be a two-way handshake process during which the wireless device determines which access point to associate with. Security and operating parameters may be exchanged between the wireless device and the access point during the association process. For example, the association process may comprise an association request and a response to the association request. The wireless device may obtain an association identifier (AID) by performing the authentication and association process.

Wireless devices may perform the authentication and association process on an individual basis. Because each wireless device performs these processes individually, a network may be flooded with authentication and association requests. Performing the authentication and association individually may be inefficient in terms of power and spectrum.

A random access transmission opportunity, such as a TXOP as defined in a Wi-Fi or 802.11 standard, may be used for authentication and association. Regardless of whether or not any wireless devices use the random access transmission opportunity, the access point may wait until the end of the transmission opportunity before using the spectrum reserved for the transmission opportunity for other purposes. At the end of the random access transmission opportunity, the access point might not be able to anticipate whether all wireless devices have successfully found a resource element for accessing the transmission opportunity, whether there are failed wireless devices that were unable to access the spectrum, or whether there are devices that request to transmit more data. Although the transmission opportunity is described as being used for authentication and association, it should be understood that the transmission opportunity may be used for other purposes. For example, the transmission opportunity may be used for uplink data transmission.

Low power devices, such as wearable devices, may use wireless networks (e.g., Wi-Fi based networks) to transmit and receive data. These low power devices may be referred to as narrow band (NB) devices, or NB stations. NB devices may have limited power budgets. Thus, it may be desirable to minimize operations for NB devices that are in an awake state to conserve power. For example, an NB device may comprise a sensor, and it may be desirable to conserve power so that the NB device is replaced or recharged less frequently. In one implementation, an NB device may communicate on a subchannel (e.g., a 2 MHz subchannel). For example, the subchannel may be an Orthogonal Frequency-Division Multiple Access (OFDMA) subchannel. In this implementation, the NB device may coexist with devices operating on a channel (e.g., 20 MHz channels). The above bandwidth values are examples, and are not intended to be limiting. In other embodiments, subchannels may be 1 MHz, 3 MHz, or 4 MHz wide, and channels may be 10 MHz or 40 MHz wide, as examples.

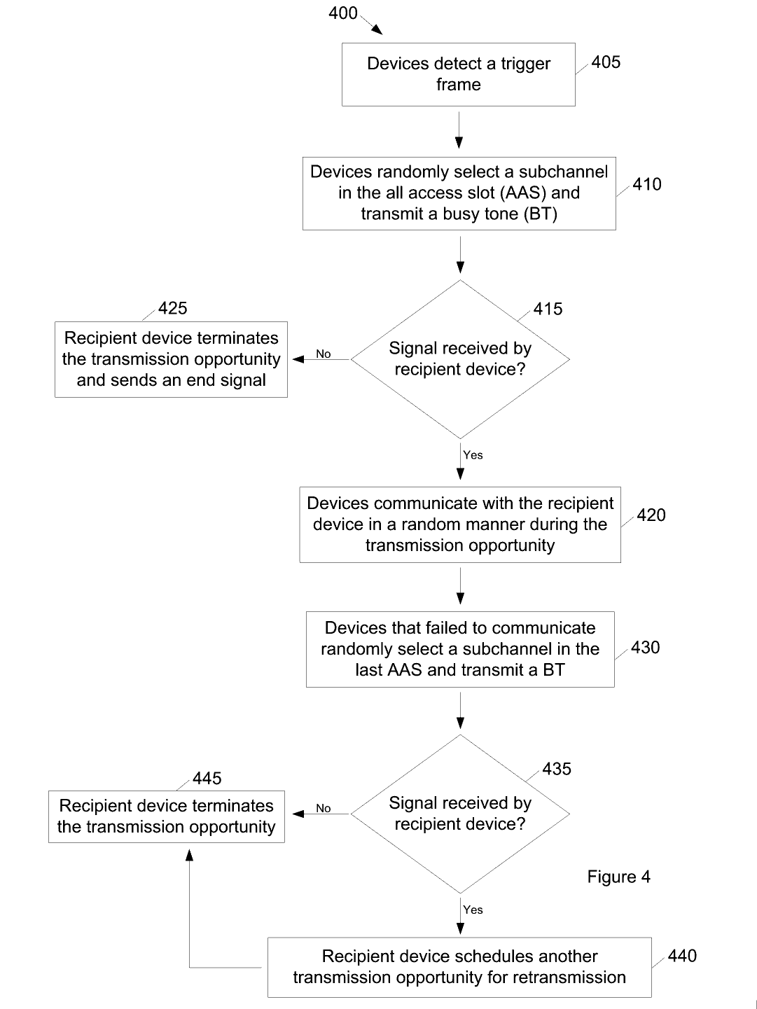

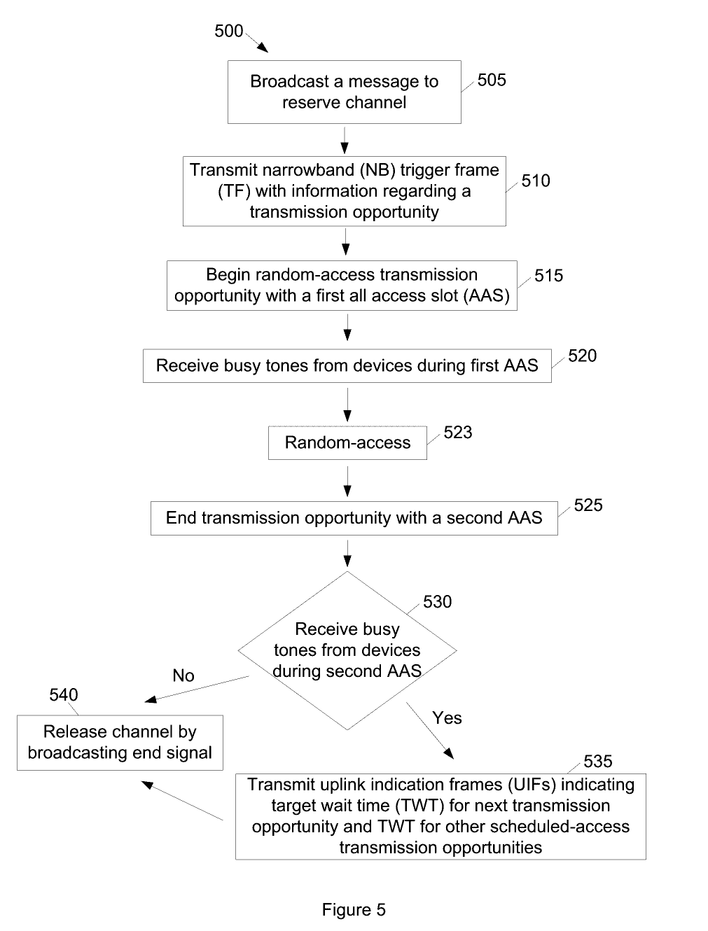

Communications that include methods for terminating the transmission opportunities, as described in FIGS. 4 and 5, may be compatible with various communication protocols, such as a Wi-Fi protocol. For example, an access point (e.g., a Wi-Fi access point) implementing a method for terminating transmission opportunities may support communications with devices, or stations, that support the termination features and communications with devices that do not support the termination features.

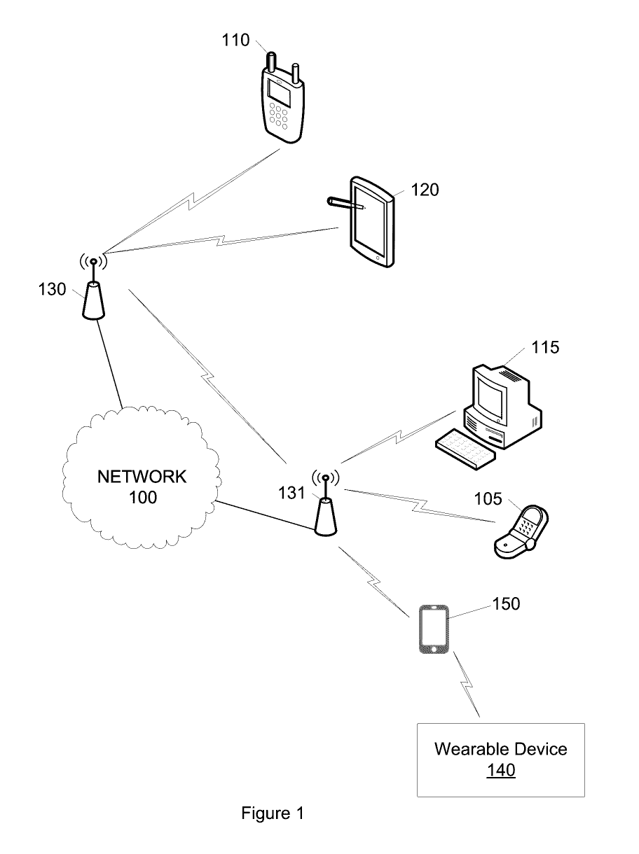

FIG. 1 is a diagram of an example communication system in which one or more embodiments may be implemented. As seen in FIG. 1, the system may include multiple recipient devices (RD) (e.g., access points) 130 and 131 and a number of sender devices (SDs) (e.g., wireless stations) 105, 110, 115, 120, 140, and 150.

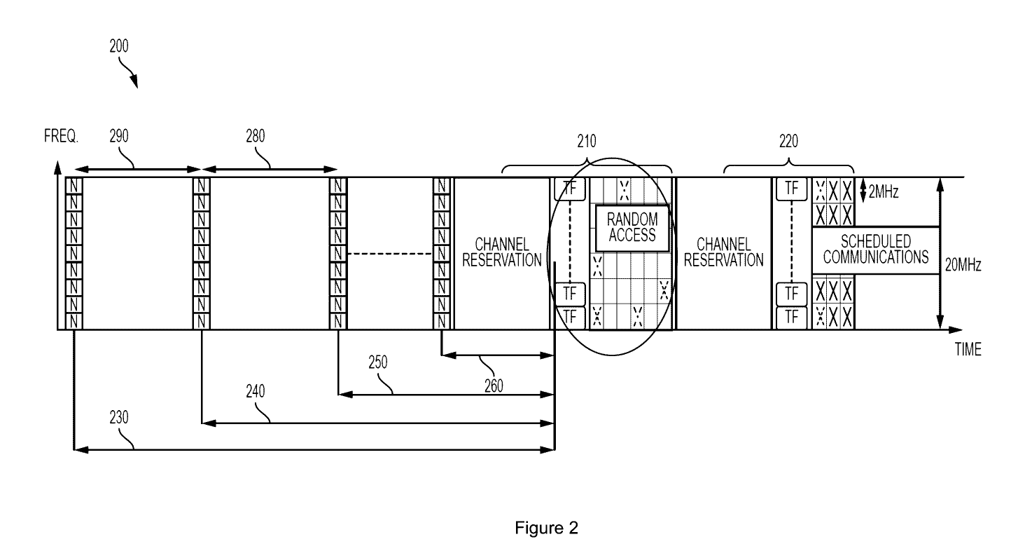

The SD 150 may comprise a gateway device, such as a smart phone device, that communicates with a wearable device 140. The wearable device 140 may communicate with the SD 150 using the transmission system described in FIG. 2. The wearable device 140 may be an NB device. NB devices may use OFDMA subchannels (e.g., sub-20 MHz OFDMA subchannels) to transmit, receive, and listen. For example, the wearable device 140 may use a 2 MHz wide OFDMA subchannel. In this example, the maximum bandwidth of a subchannel may be a multiple of 2 MHz, though other bandwidths are possible. In one implementation, the connection between the SD 150 and wearable device 140 may form a Body Area Network (BAN). The SD 150 may act as an access point for communications between the SD 150 and the wearable device 140. The SD 150 may also act as a sender device for communications between the SD 150 and the RD 131. Data transmitted from the wearable device 140 may be communicated to and stored in a cloud system (e.g., remote data storage accessible over a network). The wearable device 140 may comprise sensors, a processor, such as a microprocessor, and a radio, such as a Wi-Fi radio or Bluetooth Low Energy (BLE) radio. Although the device 140 is described as a wearable device, it should be understood that other types of devices may be used, such as devices that might not be wearable (e.g., devices that comprise the Internet of things (IoT), such as home automation devices (e.g., Internet connected alarm system, garage door opener, sprinkler system, etc.), or devices that implement machine to machine (M2M) technologies, such as cargo tracking devices, etc.). For example, the wearable device 140 may comprise an on-body, off-body, or in-body sensor.

Each recipient device may be associated with a plurality of sender devices to form a group of devices that communicate together (e.g., an independent or infrastructure basic service set (BSS)). For example, RD 130 and SDs 110 and 120 may form a first communication group (i.e., a first BSS) and RD 131 and SDs 105, 115, 140, and 150 may form a second communication group (i.e., a second BSS). While the RD of each communication group may cover different geographical areas (e.g., basic service areas (BSAs)), the communication groups may also cover some common locations such that the communication groups are overlapping (e.g., overlapping BSS (OBSS)). For overlapping communication groups, an SD may be associated with one RD, but be within communication range of another RD such that it could switch from the first communication group to the second communication group. While devices may be described herein as a sender device or a recipient device for convenience, such devices may be capable of bi-directional data transmissions and may include transceivers as opposed to just transmitters or receivers. These devices described as sender devices and recipient devices may switch roles to operate as recipient devices and sender devices respectively to support other data transactions in various embodiments (e.g., downlink transmissions from an access point to a station, broadcast transmissions from a central device to multiple remote devices, etc.).

FIG. 2 illustrates an NB transmission diagram 200 according to one or more embodiments described herein. All or portions of the illustrated NB transmission diagram 200 might not be drawn to scale. For example, a channel reservation signal may comprise less time than the channel reservation as illustrated in the diagram 200. The transmission diagram 200, illustrated in FIG. 2, may comprise transmissions that are compatible or compliant with a Wi-Fi protocol, or other wireless communication protocols. The diagram 200 illustrates communications, which may comprise NB communications, over a period of time and by frequency. First, an NB-beacon is transmitted (identified by multiple subchannel transmissions “N”) at the initial time, and then NB-beacons are transmitted again after intervals 280 and 290. The first NB-beacon may comprise a target wait time (TWT) 230. The TWT 230 may indicate an amount of time between the NB-beacon and a transmission opportunity 210. The second NB-beacon may comprise a TWT 240. The third NB-beacon may comprise a TWT 250. The fourth NB-beacon may comprise a TWT 260. A device receiving the NB-beacon may sleep, or halt wireless communications, for the time period specified by one of the TWTs 230-60. The TWTs 230-60 may indicate an amount of time until a first transmission opportunity 210 begins, or until after a channel reservation signal has been transmitted for the first transmission opportunity 210. The transmission opportunity 210 may be scheduled after a single NB-beacon (e.g., without the second, third, fourth, etc. NB-beacons) or after multiple NB-beacons (e.g., with the second, third, fourth, or more NB-beacons). In one implementation, the number of NB-beacons that occur prior to the transmission opportunity 210 may depend on the density of NB devices, or stations. Although the TWTs 230-60 are described as being transmitted or received in NB-beacons, the TWTs 230-60 may be transmitted or received in other types of messages.

To begin the transmission opportunity 210, an access point, such as one of the RDs 130-31, may emit a first transmission, i.e., a channel reservation signal, to reserve a channel. The first transmission may, for example be a clear to send (CTS) message, and may be referred to as a CTS-to-self message. A trigger frame (TF) may then be emitted by the access point. For example, the TF may be emitted at a time after the channel reservation signal is emitted. Devices, i.e., stations, or SDs 105, 110, 115, 120, 140, or 150, that will attempt to communicate with the access point during the transmission opportunity 210 may wake to receive the TF. In one implementation, the TF may be transmitted prior to the scheduled start time of the transmission opportunity 210, and devices may wake prior to the scheduled time of the transmission opportunity to receive the TF. The TF may comprise a description of resource element dimensions, transmission opportunity duration, or other information regarding the transmission opportunity 210.

The devices may then communicate with the access point during the transmission opportunity 210. The transmission opportunity 210 may be a random-access transmission opportunity. In one embodiment, the random-access transmission opportunity may be for authentication and association. In another embodiment, the random-access transmission opportunity may be for a general purpose communication, such as for enabling uplink data transmissions. During a random-access transmission opportunity, stations may transmit uplink frames in a random fashion. For example, the stations may randomly select an available frequency and/or time, i.e., a resource element, for communication during the transmission opportunity 210.

Following the transmission opportunity 210, the transmission opportunity 220 may be used for scheduled communications, including upload and download data communications. The scheduled communications that occur during transmission opportunity 220 may be based on the communications that occurred during the transmission opportunity 210. For example, an AID may be obtained by a wireless device during the transmission opportunity 210, and used by the wireless device during the transmission opportunity 220. In FIG. 2, resource elements (e.g., a time slot and a subchannel) in the transmission opportunities 210 and 220 that are used by devices are marked with an ‘X’ symbol.

A random-access transmission opportunity, such as transmission opportunity 210, may comprise a set time period. The set time period may comprise a time period between the start of the transmission opportunity and the end of the transmission opportunity, which may be predefined, or preset. The set time period of the transmission opportunity may be set before the transmission opportunity, when initiating the transmission opportunity, or at any other time. Various embodiments may terminate the transmission opportunity 210 prior to the set time period in certain instances. Methods 400 and 500, described below and in FIGS. 4 and 5, may be used to terminate the transmission opportunity 210 prior to the set time period.

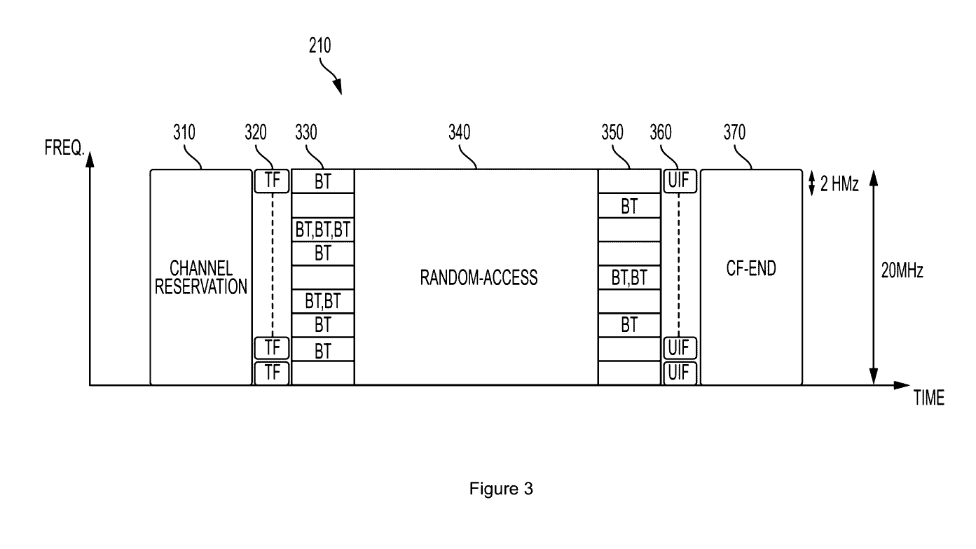

FIG. 3 illustrates the random access transmission opportunity 210 according to one or more embodiments described herein. All or portions of the transmission opportunity 210 illustrated in FIG. 3 might not be drawn to scale. For example, a CF-End frame may comprise less time than the CF-End frame 370 as illustrated in the diagram 210. The access point, for example, the SD 150 or the SD 131 described in FIG. 1, may transmit a channel reservation (e.g., a CTS-to-self) message 310 to reserve a channel for the transmission opportunity 210. For example, the access point may transmit the channel reservation message 310 after executing a traditional carrier sense multiple access with collision avoidance (CSMA/CA) protocol. The access point may transmit TFs 320, as described above in FIG. 2, comprising information regarding the transmission opportunity 210. The TFs 320 may have a width, for example, of 2 MHz. The TFs 320 may be received by wireless devices.

In one implementation, a TF 320 may be transmitted on only one subchannel, which may be referred to as a primary subchannel. In this implementation, the primary subchannel may be known to the wireless devices, and the wireless devices may listen on the primary subchannel for the TF 320. In another implementation, TFs 320 may be transmitted on a plurality of subchannels. For example, the TFs 320 may be transmitted on every subchannel of a channel. The TFs 320 may comprise information corresponding to all subchannels, or a TF 320 may only comprise information corresponding to the subchannel on which the TF 320 is transmitted.

During a first all access slot (AAS) 330, devices that intend to transmit data during the transmission opportunity 210 may transmit a signal on a selected subchannel. The signal may indicate to the access point that the device is requesting to or configured to use the transmission opportunity 210. The signal may be a busy tone (BT) signal. In one implementation, the devices may select the subchannel before receiving a TF 320. In another implementation, the devices may select the subchannel after receiving the TF 320. The subchannel, and a time slot, may be selected in a random manner.

After the first AAS 330, a random access period 340 may occur. During the random access period 340, devices may execute authentication and association protocols, or other types of communication, such as uplink data communication, with the access point. The authentication and association protocols may be executed in a random manner. Devices that successfully authenticate and associate with the access point may receive an AID. A second AAS 350 may occur after the random access period 340. During the second AAS 350, devices that failed to transmit during the random access period 340, devices that have more data to transmit, or devices that request to use a second transmission opportunity for any other reason, may transmit a signal, such as a BT, on a selected subchannel. For example, devices that were unable to authenticate and associate (or generally communicate) with the access point during the random access period 340 because of a collision may transmit a BT during the second AAS 350. The first AAS 330 and the second AAS 350 may comprise the same frequency range, duration, or both.

The random access period 340 may comprise a plurality of resource elements. Each resource element may be a time slot and a subchannel, or frequency, for communications with the access point. During the random access period 340, wireless devices may use one or more of the resource elements to communicate with the access point.

Uplink indication frames (UIFs) 360 may be transmitted by the access point to the stations after the second AAS 350. The UIFs 360 may have, for example, a width of 2 MHz. The UIFs 360 may comprise a TWT for a next random-access transmission opportunity. For example, if one or more BTs are received during the second AAS 350, the UIF 360 may comprise the TWT for the next random-access transmission opportunity, which may be referred to as a retransmission transmission opportunity. In another example, if no BTs are received during the second AAS 350, the UIF 360 would not comprise the TWT for the next random-access transmission opportunity, because there would not be a retransmission transmission opportunity. The UIFs 360 may comprise a TWT for each of one or more scheduled-access transmission opportunities, such as the transmission opportunity 220.

The access point may release the channel by broadcasting a CF-end frame 370. The CF-end frame 370 may be a 20 MHz based frame. The CF-end frame 370 may be received by one or more NB devices or by one or more non-NB devices. In one implementation, the CF-end frame may be received by non-NB devices but might not be received by NB devices. The CF-end frame 370 may be received by devices implementing the methods described herein or devices that do not. For example, the CF-end frame 370 may be received by a Wi-Fi compliant device. The CF-end frame 370 may cause devices to update their network allocation vector (NAV). A device's NAV may comprise an indicator of whether a spectrum is busy or available for communications. For example, if the random-access transmission opportunity 210 ends earlier than was broadcasted in the channel reservation message 310, the devices receiving the CF-end frame 370 may lower, or reset, their NAV.

As described above, a random-access transmission opportunity, such as the random access transmission opportunity 210, may be terminated, or repeated, based on signals received from devices communicating with the access point. Method 400 describes steps that may be used to perform the communications illustrated in FIGS. 2 and 3.

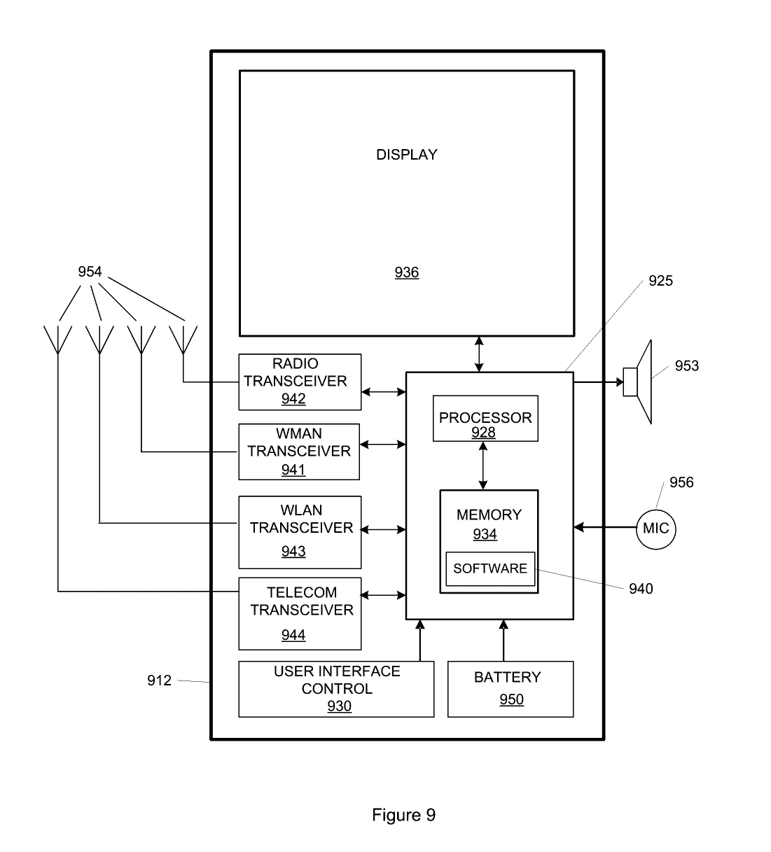

FIG. 4 is a method 400 for wireless communications according to one or more embodiments described herein. In one or more embodiments, the method 400 or one or more steps thereof may be performed by one or more computing devices or entities. For example, portions of the method 400 may be performed by components of the device 912, described in FIG. 9, or one or more of the devices 105-50, described in FIG. 1. The method 400 or one or more steps thereof may be embodied in computer-executable instructions that are stored in a computer-readable medium, such as a non-transitory computer-readable medium. The steps in method 400 might not all be performed in the order specified and some steps may be omitted or changed in order.

At step 405, wireless devices may detect a TF. For example, the devices may detect one of the TFs 320. The TF may indicate a resource element dimension, transmission opportunity duration, or other information regarding an upcoming transmission opportunity, such as the random-access transmission opportunity 210. The TF may comprise an indication of a channel reservation for a plurality of stations. The channel reservation may comprise a busy tone slot and a plurality of resource elements. For example, the TF may describe time periods and subchannels for the busy tone slot and the resource elements.

At step 410, devices intending to use the upcoming transmission opportunity may select a subchannel in a first AAS and transmit a BT. The devices intending to use the upcoming transmission opportunity may be devices that intend to authenticate and associate with an RD, such as the RD 130 or 131, which may comprise an access point. The subchannel may be selected based on information in the TF. In one implementation, the NB stations may randomly select a subchannel in the first AAS. In another implementation, the NB stations may select a predetermined, or preset, subchannel in the first AAS. Although the signal transmitted by the devices at step 410 is described as a BT signal, other types of signals may be used in addition to or as an alternative to a BT signal.

At step 415, the RD may determine whether any BTs emitted at step 410 were received, or detected, by the RD. In one implementation, the RD may determine whether any BTs were emitted by measuring the energy level on each of the subchannels of the first AAS. If no BTs were received by the RD, the method 400 may continue to step 425.

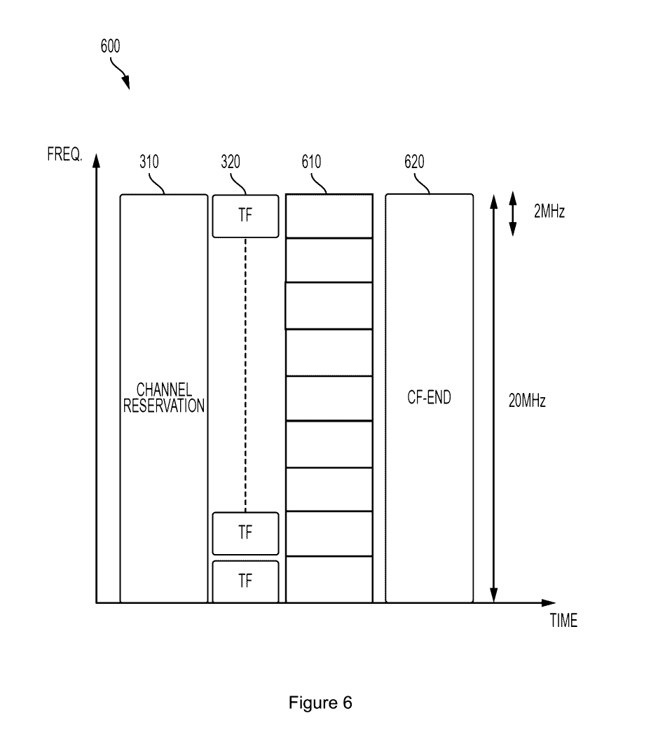

At step 425, the RD may terminate the transmission opportunity and transmit an end signal, such as a CF-end frame. If the RD did not receive any BTs during the first AAS, the RD may determine that no NB devices are willing to use the current transmission opportunity. Rather than continue with a transmission opportunity that will not be used by the NB devices, the RD may terminate the transmission opportunity to allow other devices to access the spectrum. For example, legacy stations, i.e., non-NB stations, may apply regular CSMA/CA protocols to access the spectrum after the random access transmission opportunity has been terminated at step 425. FIG. 6, discussed below, illustrates one example of a transmission opportunity that is terminated after no BTs are detected during a first AAS.

If one or more BTs were received by the RD at step 415, the method 400 may continue to step 420. At step 420, devices may communicate with the RD in a random manner during the transmission opportunity. Step 420 may correspond to the random-access 340 described in FIG. 3. The devices may transmit and receive data during step 420. The devices may authenticate and associate with the access point at step 420. For example, security and operating parameters may be exchanged between the RD and a wireless device, such as an NB station, at step 420.

During the communications that occur at step 420, one or more devices that intended to communicate with the RD might not be able to communicate with the access point. For example a device that attempted to communicate with the RD might not successfully authenticate and associate with the RD at step 420. The NB stations might not be able to communicate with the RD because a collision has occurred. For example, the NB station might not be able to find a resource element, i.e., a time-slot and subchannel, to communicate with an RD. A collision may occur if multiple devices attempt to access the same resource element.

At step 430, the devices that failed to communicate with the RD at step 420, or devices that request to transmit additional data, may transmit a BT. The actions performed at step 430 may be performed during a second AAS, such as the second AAS 350 described in FIG. 3. In one implementation, a failed device may transmit a BT on the same subchannel in the first AAS 330 and the second AAS 350. For example, a device may randomly select a subchannel for the first AAS 330, and then use the randomly selected subchannel for the second AAS 350. In another implementation, a failed device may randomly select a subchannel to transmit a BT on during the second AAS 350. In this implementation, the failed device may transmit on the same subchannel during the first AAS 330 and the second AAS 350, or on different subchannels during the first AAS 330 and the second AAS 350. Actions performed at step 430 may be similar to the actions performed at step 410.

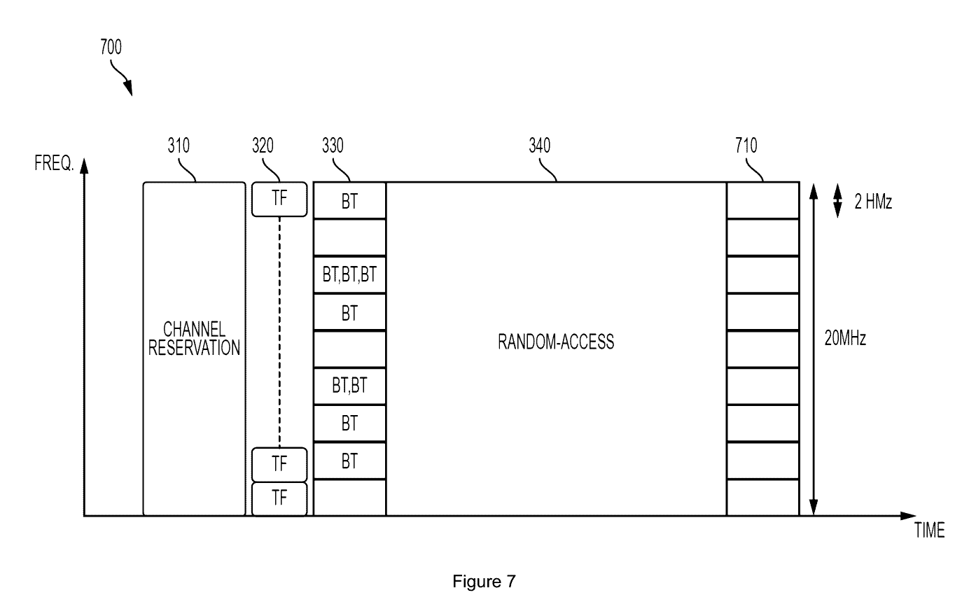

At step 435, the RD may determine if any BTs were received during the second AAS. If the RD determines that no BT signals were received during the second AAS, the method 400 may continue to step 445. FIG. 7, discussed below, illustrates one example of a transmission opportunity in which no BTs are received during the second AAS. In one implementation, if no signals were detected during the second AAS, the transmission opportunity may be terminated without transmitting an end signal, such as a CF-end signal.

At step 445, the access point terminates the transmission opportunity. Because no BT signals were received during the second AAS, the access point may determine that all devices that sought to communicate with the RD during the transmission opportunity successfully communicated. Actions performed at step 445 may be similar to those performed at step 425.

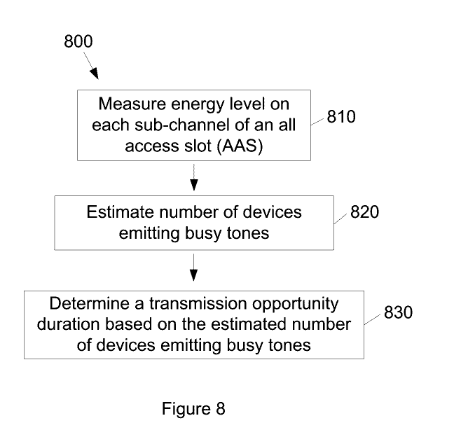

If, at step 435, the RD determines that one or more BT signals were received during the second AAS, the method 400 may continue to step 440. At step 440, the RD may schedule a second transmission opportunity. To schedule the second transmission opportunity, the RD may transmit one or more UIFs comprising a TWT and channel index for the second transmission opportunity. In one implementation, the duration of the second transmission opportunity may be determined by estimating a number of devices, such as failed devices, that will transmit during the second transmission opportunity, as described below in method 800 and FIG. 8.

At step 440 or 445, the RD may transmit one or more UIFs, such as the UIFs 360, at the end of the transmission opportunity. For example, the UIFs may be transmitted after the second AAS. In this implementation, the UIF may include TWTs for random-access or scheduled-access transmission opportunities, or a TWT of a retransmission transmission opportunity for any devices that failed to communicate with the RD during the first transmission opportunity Although the transmission opportunity is referred to as a retransmission transmission opportunity, the retransmission transmission opportunity may be used for other purposes. For example, a device that has more data to transmit may use the retransmission transmission opportunity to transmit the additional data.

Following step 440, the method may proceed to step 445, where the RD terminates the transmission opportunity. After step 445, if the RD detected one or more BTs during the second AAS and the method proceeded from step 435 to step 440, the RD may perform the retransmission transmission opportunity by performing similar actions to those performed at step 420. If any collisions occur during the retransmission transmission opportunity, further retransmission transmission opportunities may be performed.

All or portions of method 400 may be performed by NB devices, such as wearable devices, sensors, or RDs 130 and 131 that are configured to communicate with NB devices.

FIG. 5 illustrates a method 500 for initiating and terminating a transmission opportunity according to one or more embodiments described herein. In one or more embodiments, the method 500 or one or more steps thereof may be performed by one or more computing devices or entities. For example, portions of the method 500 may be performed by components of the device 912, described in FIG. 9, or one or more of the devices 105-50, described in FIG. 1. The method 500 or one or more steps thereof may be embodied in computer-executable instructions that are stored in a computer-readable medium, such as a non-transitory computer-readable medium. The steps in method 500 might not all be performed in the order specified and some steps may be omitted or changed in order.

Method 500 may describe actions performed by an RD, such as the RDs 130 and 131, or an access point, initiating a transmission opportunity with wireless devices, such as NB stations. For example, method 500 may describe actions performed by the RD while method 400 is performed.

At step 505, the RD may broadcast a message, or frame, to reserve a channel for a transmission opportunity. The message may be a CTS-to-self message, a TF, an NB-beacon, or any other type of frame that comprises an indication of a channel reservation. For example, the RD may broadcast the CTS-to-self message 310. The channel reservation may comprise at least one BT slot and a plurality of resource elements. In one implementation, the RD may broadcast a plurality of messages to reserve the channel. For example, a CTS-to-self message may be broadcast to indicate the channel reservation to non-NB devices, and a TF may be broadcast to indicate the channel reservation to NB devices.

At step 510, the RD may transmit one or more NB TFs with information regarding an upcoming transmission opportunity. For example, the RD may broadcast the TFs 320.

At step 515, the RD may initiate a first AAS. The first AAS may be initiated at a time that was transmitted to devices in the TFs at step 510.

At step 520, the RD may receive BT signals from devices during the first AAS. If no BT signals are received by the access point during the first AAS, the method 500 may proceed to step 540 to end the transmission opportunity.

At step 523, the RD may initiate a random access period. For example, the random access period 340 may occur at step 523. During the random access period, devices may authenticate and associate with the RD. The RD may determine an AID for each device that authenticates and associates, and transmit each AID to the corresponding device.

At step 525, the RD may initiate a second AAS. For example, the second AAS 350 may occur at step 525. The second AAS may comprise the same subchannels, or frequencies, as the first AAS. For example, the second AAS may comprise subchannels that were described in the TFs transmitted at step 510.

At step 530, the RD may receive one or more BT signals during the second AAS. If no BTs are received by the RD at step 530, the method 500 may proceed to step 540, thereby terminating the transmission opportunity. Otherwise, if BTs are received by the RD at step 530, the method 500 may proceed to step 535.

At step 535, the RD may transmit one or more UIFs indicating a TWT for a retransmission transmission opportunity or a TWT for other scheduled access transmission opportunities. For example, the UIFs 360 may be transmitted at step 535.

At step 540, the RD may release the channel by broadcasting an end signal, such as a 20 MHz CF-end frame. For example, the CF-end frame 370 may be transmitted at step 540. Step 540 may terminate the transmission opportunity.

After step 540, the RD may perform one or more retransmission transmission opportunities. For example, the RD may perform retransmission transmission opportunities until all wireless devices that request to authenticate and associate with the RD have done so, or until all wireless devices that request to transmit data have done so.

FIG. 6 illustrates a terminated transmission opportunity 600 according to one or more embodiments described herein. All or portions of the transmission opportunity 600 illustrated in FIG. 6 might not be drawn to scale. For example, a channel reservation or CF-End frame may comprise less time than the channel reservation 310 or CF-End frame 370 as illustrated in the diagram 210. The channel reservation 310 and TFs 320 begin the transmission opportunity 600. At the AAS 610, no BTs are received. The transmission opportunity 600 is then terminated by the CF-end frame 620. Because no BTs were received during the AAS 610, the transmission opportunity 600 does not comprise a random access period comprising resource elements.

As described at step 425, the CF-End frame 620 may cause a device that receives the CF-End frame to reset the device's NAV. The CF-End frame may be transmitted responsive to the determination that no BTs were received during the AAS 610. The transmission opportunity 600 in FIG. 6 may correspond to the steps 405, 410, 415, and 425 in FIG. 4.

FIG. 7 illustrates a transmission opportunity 700 with no failed devices according to one or more embodiments described herein. All or portions of the transmission opportunity 700 illustrated in FIG. 7 might not be drawn to scale. For example, a channel reservation may comprise less time than the channel reservation 310 as illustrated in the diagram 210. The transmission opportunity 700 may begin with the channel reservation 310 and TFs 320. During the first AAS 330, BTs are detected, so, unlike the transmission opportunity 600, the random access period 340 may occur during the transmission opportunity 700. At a second AAS 710, no BTs are detected. For example, if all devices were able to communicate during the random-access period 340, the devices might not transmit any BTs during the second AAS 710. The transmission opportunity 700 is terminated after the second AAS 710. The transmission opportunity 700 may be terminated in response to the determination that no BT signals were detected during the second AAS 710. Though not illustrated in FIG. 7, the transmission opportunity 700 may be terminated by transmitting a CF-End frame. The transmission opportunity 700 in FIG. 7 may correspond to steps 405, 410, 415, 420, 430, 435, and 445 in FIG. 4. Because no failed devices were detected during the second AAS 710, a retransmission transmission opportunity might not be performed.

FIG. 8 illustrates a method 800 for determining a transmission opportunity duration according to one or more embodiments described herein. In one or more embodiments, the method 800 or one or more steps thereof may be performed by one or more computing devices or entities. For example, portions of the method 800 may be performed by components of the device 912, described in FIG. 9, or one or more of the RDs 130 and 131, described in FIG. 1. The method 800 or one or more steps thereof may be embodied in computer-executable instructions that are stored in a computer-readable medium, such as a non-transitory computer-readable medium. The steps in method 800 might not all be performed in the order specified and some steps may be omitted or changed in order.

Method 800 may be performed to determine a transmission opportunity duration, or other attributes of a transmission opportunity. For example, method 800 may be performed to determine a duration for the transmission opportunity 210, or for a second, or retransmission, transmission opportunity.

At step 810, an energy level may be measured on each sub-channel of an AAS. For example, the energy level may be measured for each sub-channel of the first AAS 330 or second AAS 350. The measured energy levels may correspond to the number of BT signals emitted by devices, such as NB stations, during the AAS. The energy level of each subchannel may be summed to form a measured energy level for the AAS.

At step 820, a number of devices that emitted BTs during the AAS may be estimated or determined. The devices may use a fixed power level for the BT signals transmitted during the AAS. The fixed power level may be known by the RD. Based on this fixed power level, and the energy levels measured at step 810, the number of devices that emitted BTs may be estimated. For example, the measured energy level for the AAS may be divided by the fixed power level to estimate the number of devices transmitting BTs.

Alternatively, at step 820, a number of subchannels for which signals were received during the AAS may be determined. As described at step 810, energy levels for each subchannel may be detected during an AAS. If the energy level of a subchannel exceeds a preset threshold, it may be determined that one or more devices transmitted signals on that subchannel. The number of subchannels that exceed the threshold may be counted at step 820 and then used at step 830.

At step 830, a transmission opportunity duration may be determined based on the estimated number of devices from step 820, or a determined number of subchannels. For a higher number of devices, or subchannels, detected at step 820, the duration of the transmission opportunity may be longer, and for a lower number of devices, or subchannels, detected at step 820, the duration of the transmission opportunity may be shorter.

Additionally, a length between a first transmission opportunity and a retransmission transmission opportunity may be determined based on the estimated number of devices, or the determined number of subchannels. If a smaller number of devices are determined at step 820, the retransmission transmission opportunity may be given a lower weight in terms of being urgent, and the TWT of the retransmission transmission opportunity may be set to a longer time from the first transmission opportunity. If a larger number of devices is determined at step 820, the retransmission transmission opportunity may be given a higher weight in terms of being urgent, and the TWT of the retransmission transmission opportunity may be set to a shorter time from the first transmission opportunity.

FIG. 9 illustrates a block diagram of an example communication device according to one or more embodiments described herein. The example communication device, in particular, a computing device 912, may be used in a communication network such as the one illustrated in FIG. 1, to implement any or all of SDs or RDs described and illustrated herein. Computing device 912 may include a controller 925 connected to a user interface control 930, display 936 and other elements as illustrated. Controller 925 may include circuitry, such as one or more processors 928 and one or more memory 934 storing software 940, for example, client software, user interface software, server software, etc.

Device 912 may also include a battery 950 or other power supply device, speaker 953, and one or more antennae 954. Device 912 may include user interface circuitry, such as user interface control 930. User interface control 930 may include controllers or adapters, and other circuitry, configured to receive input from or provide output to a keypad, touch screen, voice interface, for example, via microphone 956, function keys, joystick, data glove, mouse and the like. The user interface circuitry and user interface software may be configured to facilitate user control of at least some functions of device 912 though use of a display 936. Display 936 may be configured to display at least a portion of a user interface of device 912. Additionally, the display may be configured to facilitate user control of at least some functions of the device (for example, display 936 could be a touch screen).

Software 940 may be stored within memory 934 to provide instructions to processor 928 such that when the instructions are executed, processor 928, device 912 or other components of device 912 are caused to perform various functions or methods such as methods 400, 500, or 800. The software may comprise machine executable instructions and data used by processor 928 and other components of computing device 912 may be stored in a storage facility such as memory 934 or in hardware logic in an integrated circuit, ASIC, etc. Software may include both applications and operating system software, and may include code segments, instructions, applets, pre-compiled code, compiled code, computer programs, program modules, engines, program logic, and combinations thereof.

In various embodiments, the SDs may include software that is configured to coordinate the transmission and reception of information to and from other devices through the RDs, other SDs, or the network. In one arrangement, client (e.g., SD) software may include specific protocols for requesting and receiving content through the wireless network. Client software may include instructions that cause one or more components, for example, a processor, wireless interface, or a display of the SDs, to perform various functions and methods including those described herein. The RDs may include similar software as the SDs.

Memory 934 may include any of various types of tangible machine-readable storage medium, including one or more of the following types of storage devices: read only memory (ROM) modules, random access memory (RAM) modules, magnetic tape, magnetic discs (for example, a fixed hard disk drive or a removable floppy disk), optical disk (for example, a CD-ROM disc, a CD-RW disc, a DVD disc), flash memory, and EEPROM memory. As used herein (including the claims), a tangible or non-transitory machine-readable storage medium is a physical structure that may be touched by a human. A signal would not by itself constitute a tangible or non-transitory machine-readable storage medium, although other embodiments may include signals or ephemeral versions of instructions executable by one or more processors to carry out one or more of the operations described herein.

As used herein, processor 928 (and any other processor or computer described herein) should be understood to encompass any of various types of well-known computing structures including but not limited to one or more microprocessors, special-purpose computer chips, field-programmable gate arrays (FPGAs), controllers, application-specific integrated circuits (ASICs), combinations of hardware/firmware/software, or other special or general-purpose processing circuitry.

As used in this application, the term ‘circuitry’ may refer to all of the following: (a) hardware-only circuit implementations (such as implementations in only analog and/or digital circuitry) and (b) combinations of circuits and software (or firmware), such as (as applicable): (i) to a combination of processor(s) or (ii) to portions of processor(s)/software (including digital signal processor(s)), software, and memory(ies) that work together to cause an apparatus, such as a mobile phone, wearable device, or server, to perform various functions) and (c) to circuits, such as a microprocessor(s) or a portion of a microprocessor(s), that require software or firmware for operation, even if the software or firmware is not physically present.

These examples of ‘circuitry’ apply to all uses of this term in this application, including in any claims. As an example, as used in this application, the term ‘circuitry’ would also cover an implementation of merely a processor (or multiple processors) or portion of a processor and its (or their) accompanying software and/or firmware. The term ‘circuitry’ would also cover, for example, a baseband integrated circuit or applications processor integrated circuit for a mobile phone or a similar integrated circuit in a server, a cellular network device, or other network device

Device 912 or its various components may be mobile and be configured to receive, decode and process various types of transmissions including transmissions in a Wi-Fi networks according the IEEE 802.11 WLAN standards, (e.g., 802.11n, 802.11ac, etc.) or wireless metro area network (WMAN) standards (e.g., 802.16), through a specific one or more WLAN transceivers 943 and WMAN transceivers 941. Additionally or alternatively, device 912 may be configured to receive, decode, and process transmissions through various other transceivers, such as FM/AM radio transceiver 942, and telecommunications transceiver 944.

Although the above description of FIG. 9 generally relates to a mobile device, other devices or systems may include the same or similar components and perform the same or similar functions and methods. For example, a computer 115 communicating over a wired network connection, or a wearable device 140, may include the components or a subset of the components described above, and may be configured to perform the same or similar functions as device 912 and its components.

Although specific examples of carrying out the invention have been described, those skilled in the art will appreciate that there are numerous variations and permutations of the above-described systems and methods that are contained within the spirit and scope of the invention as set forth in the appended claims.

1. A method, comprising:
receiving, by an apparatus, an indication of a channel reservation for a plurality of stations, wherein the channel reservation comprises at least one busy tone slot and a plurality of resource elements; and
transmitting, by the apparatus, a signal on the at least one busy tone slot to indicate a request to use a resource element of the plurality of resource elements.

2. The method of claim 1, wherein each of the plurality of resource elements comprises a time slot and a subchannel.

3. (canceled)

4. The method of claim 1, wherein the channel reservation comprises a random access transmission opportunity.

5. (canceled)

6. The method of claim 1, wherein the at least one busy tone slot comprises:
a first busy tone slot before the plurality of resource elements; and
a second busy tone slot after the plurality of resource elements.

7. The method of claim 1, wherein transmitting the signal on the at least one busy tone slot comprises transmitting the signal to indicate an intention to transmit data on one of the resource elements.

8. The method of claim 1, further comprising transmitting a signal on the at least one busy tone slot to indicate a failed transmission or a request to transmit additional data.

9. (canceled)

10. The method of claim 1, further comprising:
selecting, by the apparatus, the resource element of the plurality of resource elements; and
transmitting, by the apparatus, a frame in the resource element of the plurality of resource elements, and
wherein transmitting the signal on the at least one busy tone slot comprises transmitting the signal on a subchannel corresponding to the resource element of the plurality of resource elements.

11. (canceled)

12. An apparatus comprising:
at least one processor; and
at least one memory including computer program code, the at least one memory and the computer program code configured to, with the at least one processor, cause the apparatus to:
receive an indication of a channel reservation for a plurality of stations, wherein the channel reservation comprises at least one busy tone slot and a plurality of resource elements; and
transmit, by the apparatus, a signal on the at least one busy tone slot to indicate a request to use a resource element of the plurality of resource elements.

13. The apparatus of claim 12, wherein the code is further configured to cause the apparatus to:
select, by the apparatus, the resource element of the plurality of resource elements; and
transmit, by the apparatus, a frame in the resource element of the plurality of resource elements, and
wherein transmitting the signal on the at least one busy tone slot comprises transmitting the signal on a subchannel corresponding to the resource element of the plurality of resource elements.

14. The apparatus of claim 12, wherein the at least one busy tone slot comprises:
a first busy tone slot before the plurality of resource elements; and
a second busy tone slot after the plurality of resource elements.

15. The apparatus of claim 12, wherein each of the plurality of resource elements comprises a time slot and a subchannel.

16. (canceled)

17. The apparatus of claim 12, wherein the channel reservation comprises a random access transmission opportunity.

18. (canceled)

19. The apparatus of claim 12, wherein the code that causes the apparatus to transmit the signal on the at least one busy tone slot comprises code that causes the apparatus to transmit the signal to indicate an intention to transmit data on one of the resource elements.

20. The apparatus of claim 12, wherein the code is further configured to cause the apparatus to transmit a signal on the at least one busy tone slot to indicate a failed transmission or a request to transmit additional data.

21. (canceled)

22. (canceled)

23. A method, comprising:
transmitting, by a computing device, an indication of a channel reservation for a transmission opportunity comprising a busy tone slot and a plurality of resource elements;
determining whether busy tone signals were received during the busy tone slot; and
if no busy tone signals were received during the busy tone slot, terminating the transmission opportunity prior to a scheduled end time of the channel reservation.

24. (canceled)

25. (canceled)

26. The method of claim 23, wherein each of the plurality of resource elements comprises a time slot and a subchannel and the transmission opportunity comprises a random access transmission opportunity.

27. (canceled)

28. The method of claim 23, wherein the transmission opportunity comprises a second busy tone slot after the plurality of resource elements, and further comprising:
receiving at least one second busy tone signal during the second busy tone slot; and
determining another transmission opportunity based at least in part on the at least one second busy tone signal.

29. An apparatus comprising:
at least one processor; and
at least one memory including computer program code, the at least one memory and the computer program code configured to, with the at least one processor, cause the apparatus to:
transmit an indication of a channel reservation for a transmission opportunity comprising a busy tone slot and a plurality of resource elements;
determine whether busy tone signals were received during the busy tone slot; and
if no busy tone signals were received during the busy tone slot, terminate the transmission opportunity prior to a scheduled end time of the channel reservation.

30. (canceled)

31. (canceled)

32. The apparatus of claim 29, wherein each of the plurality of resource elements comprises a time slot and a subchannel and the transmission opportunity comprises a random access transmission opportunity.

33. (canceled)

34. The apparatus of claim 29, wherein the transmission opportunity comprises a second busy tone slot after the plurality of resource elements, and wherein the code is further configured to cause the apparatus to:
receive at least one second busy tone signal during the second busy tone slot; and
determine another transmission opportunity based at least in part on the at least one second busy tone signal.
